(19) United States
(12) Patent Application Publication
(10) Pub. No.: US 2009/0089457 A1
(43) Pub. Date: Apr. 2, 2009

(54) RECONNECTING A HOST COMPUTER WITH A NETWORKED PRINTER HAVING A DYNAMIC NETWORK ADDRESS

(75) Inventor: Xiaonong Zhan, Foster City, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/863,738

(22) Filed: Sep. 28, 2007

(51) Int. Cl. G06F 3/12

(52) U.S. Cl. 710/4

(57) ABSTRACT

Methods and apparatus for reconnecting a host computer with a networked printer having a dynamic network address without manually entering the printer's network address. In a first method, when a user presses a reconnect button on the printer, the printer broadcasts a reconnection event containing the printer's network address over the network. The host receives the event, extracts the network address and reconnects the printer accordingly. In a second method, the host obtains the network addresses of candidate printers, displays a list of them on a UI, and sends a flash signal to the candidate printers to cause them to generate an alarm one by one. The user observes the desired printer and correlates its alarm with the timing of the flash signals sent by the host. Based on the observation, the user selects one of the candidate printers on the UI and the host reconnects it.

This application is related to commonly owned patent application entitled “Network Port Setup for Printer Driver for a Networked Printer,” Attorney Docket No. 75675.B153, filing date to be determined.

### BACKGROUND OF THE INVENTION

1. Field of the Invention

This invention relates to a networked printer system, and in particular, it relates to a method for easily reconnecting a networked printer to a host computer when the printer has a dynamic IP address.

2. Description of Related Art

In a system where multiple printers and multiple computers are connected to a network, network addresses (such as IP addresses) are often assigned to printers in a dynamic manner. Thus, a printer often has a dynamic IP address, but no unique hostname. The IP address of a printer may change, for example, when the printer is taken offline and then put back online, or when a power outage occurs, etc. Conventionally, to reconnect a printer to a host computer, the user needs to print out the configuration page of the printer to obtain its current IP address, and then manually change the port configuration for the printer on the host side (such as from Microsoft Windows) according to the correct IP address of the printer. This process tends to be cumbersome, confusing and error prone.

### SUMMARY

The present invention is directed to a method and apparatus of facilitate easy reconnection of a printer to a host that substantially obviates one or more of the problems due to limitations and disadvantages of the related art.

An object of the present invention is to provide an easy way to reconnect a host to a networked printer with a dynamic network address.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a system including one or more host computers and one or more printers connected to a network, for reconnecting a first one of the printers to a first one of the host computers, which includes: (a) manually causing the first printer to generate a reconnection event containing a network address of the first printer, the network address having been dynamically assigned to the first printer and stored in a memory of the first printer; (b) the first printer sending the reconnection event over the network to be transmitted to the one or more host computers; (c) the first host computer receiving the reconnection event and extracting the network address of the first printer; and (d) the first host computer reconnecting to the first printer using the extracted network address of the first printer.

The present invention also provide a method implemented in a system including one or more host computers and one or more printers connected to a network, for reconnecting a first one of the printers to a first one of the host computers, which includes: (a) the first host computer obtaining a plurality of candidate printers with their network addresses, the candidate printers including the first printer; (b) the first host computer displaying a list of the candidate printers on a user interface; (c) the first host computer sending flash signals to the candidate printers one by one; (d) the first printer generating an alarm in response to receiving a flash signal from the host computer; (e) a user correlating the alarm if the first printer with a timing of the flash signals sent by the host computer; (f) the user selecting one of the candidate printers on the user interface based on the observation; and (g) the host computer reconnecting to the selected printer.

In another aspect, the present invention provides a computer program product causing a host computer to carry out the above two methods, respectively.

In another aspect, the present invention provides a printer, which includes: a processor; a memory for storing an IP a network address of the printer, the network address having been dynamically assigned to the printer; a manual input device connected to the processor; and a network interface for connecting the printer to a network; wherein the processor is programmed to generate a reconnection event in response to an input from the manual input device and transmitting the reconnection event to a network via the network interface, the reconnection event containing a network address of the printer. The printer may further include an alarm generator for generating an alarm in response to receiving a flash signal from the host computer.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a block diagram of a host computer in which embodiments of the present invention may be implemented.

FIG. 2 is a block diagram of a printer according to an embodiment of the present invention.

FIG. 3 illustrates a process carried out by the printer reconnection application of the host computer according to an embodiment of the present invention.

FIG. 4 illustrates a process carried out on a networked printer being reconnected according to embodiments of the present invention.

FIG. 5 illustrates a method of reconnecting a networked printer to a host computer according to embodiments of the present invention.

FIG. 6 illustrates a networked host computer and printer system in which embodiments of the present invention may be implemented.

FIG. 7 illustrates a process of reconnecting a host computer to a networked printer according to another embodiment of the present invention.

FIG. 8 illustrates a process of reconnecting a host computer to a networked printer according to yet another embodiment of the present invention.

### DETAILED DESCRIPTION OF PREFERRED EMBODIMENTS

FIG. 6 illustrates a networked host computer and printer system 10 which includes a plurality of printers 11 and a plurality of host computers 12 connected via a network 13. The network 13 may be any suitable network, including but not limited to a LAN, WAN, Ethernet, the Internet, etc. The printers 11 and the host computers 12 may be connected to the network via wired or wireless connections. In this system, the printers may have dynamic network addresses (such as IP addresses), but no unique names. Embodiments of the present invention provide methods for reconnect a desired printer to a host computer in such a system. Two methods are described, where the two methods may be used alone (i.e. the system may implement one of the methods without the other), or in combination (e.g. the system implements both methods and either allow the user to select one of them or carries out one of them as a default method and carries out the other when the default method is not successful).

In the first reconnection method, a dedicated reconnect button is provided on the printer. When the user pushes the reconnect button, the printer broadcasts a reconnection event which contains the current network address (e.g. IP address) of the printer. A reconnection program running on the host computer will pick up the event and set up a new port with the correct IP address of this printer to reconnect the printer.

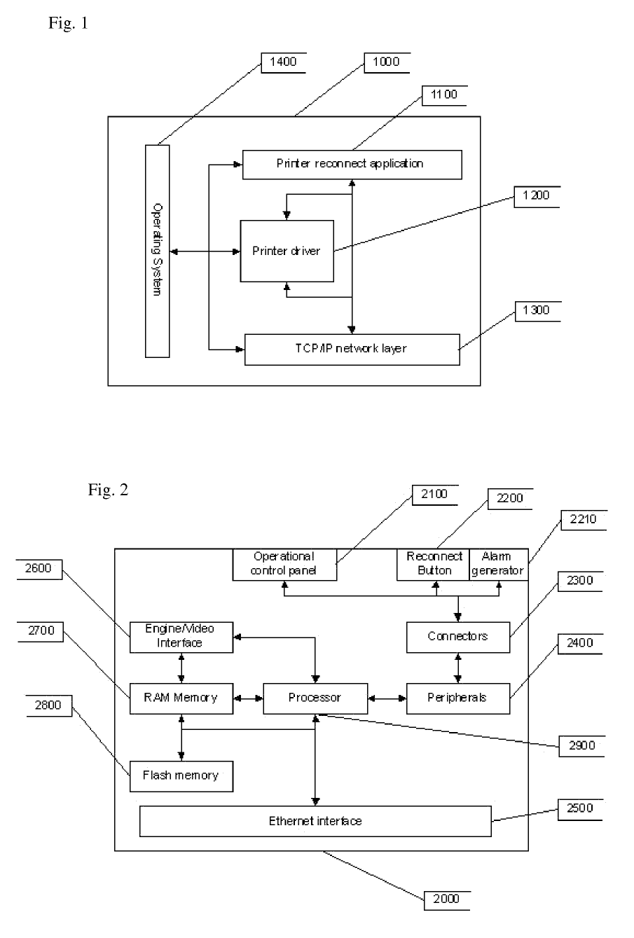

FIG. 1 illustrates a host computer in which embodiments of the present invention may be implemented. In relevant part, the host computer 1000 includes an operating system 1400, a TCP/IP layer 1300 for carrying out communication over a network, a printer driver module 1200, and a printer reconnection application 1100. These various components communicate with each other via internal structures of the computer well know to those skilled in the art. FIG. 2 illustrates a printer in which embodiments of the invention may be implemented. In relevant part, the printer 2000 includes an operation control panel 2100, a reconnect button 2200, connectors 2300, peripheral chips 2400, a network interface (such as an Ethernet interface) 2500, an engine/video interface 2600, a RAM memory 2700, a flash memory 2800 and a processor 2900. These various components communicate with each other via internal structures of the printer well know to those skilled in the art. While a dedicated reconnect button is an example of a convenient manual input device for causing the printer to generate a reconnection event, other manual input devices may be used, such as a touch screen implementing a menu tree structure. Note that the alarm generator 2210 shown in FIG. 2 is not necessary for the first method.

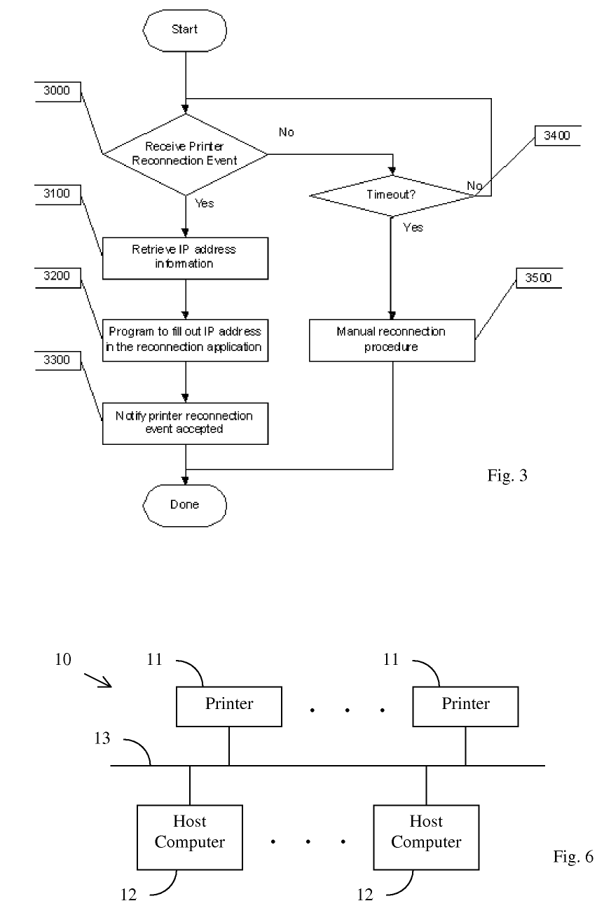

A process carried out by the printer reconnection application 1100 of the computer 1000 is shown in FIG. 3. After the printer reconnection application 1100 starts, it waits to receive a printer reconnection event from the network (step 3000). If the printer reconnection application receives a reconnection event from the network, it retrieves the network address information contained therein (step 3100). In the next step, the printer reconnection application uses the network address to fill out the network address field in the printer reconnection application to set up the network port for the printer (step 3200). In step 3300, the computer sends a reconnection acknowledgement message to the printer to notify it that the reconnection event and the network address information have been accepted. The printer reconnection application also completes the other steps of printer reconnection (not shown) in a way similar to the conventional method. If, after the printer installer application 1100 starts, it does not receive any reconnection event from the network with a predetermined time period (“yes” in step 3400), the automatic reconnection process times out, and an alternative reconnection procedure (including manual reconnection) may be carried out (step 3500). The manual reconnection procedure is similar to that in the conventional art.

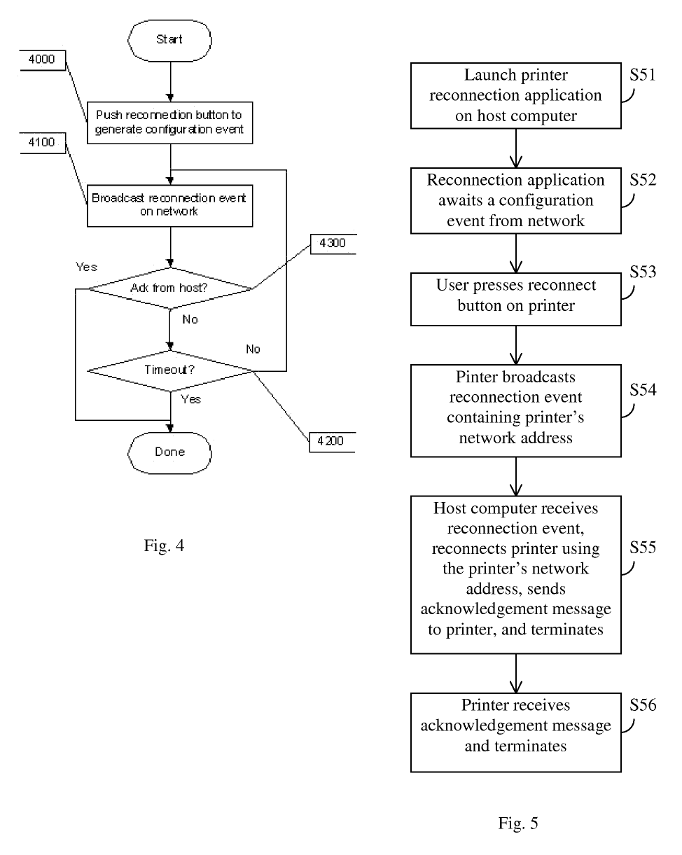

A process carried out by the printer controller of a networked printer being reconnected is illustrated in FIG. 4. This process is implemented in firmware or software on the printer controller. As described earlier, during the printer reconnection process, the user presses the reconnect button on the printer. In response to the reconnect button being pressed, the printer controller generates a reconnection event (step 4000) and broadcasts the event on the network (step 4100). This broadcast event contains the printer's network address such as its IP address. This broadcast procedure is repeated until a reconnection acknowledgement message from a host computer is received from the network (“Yes” in step 4300), or until timeout (“Yes” in step 4200).

The printer reconnection process is summarized in FIG. 5. First, the printer reconnection application is launched on the host computer (step S51). The reconnection program may be launched by the user manually, or automatically launched by another application on the host computer. The reconnection application awaits a reconnection event from the network (step S52). When the user presses the reconnection button on the printer that the user wishes to reconnect (step S53), the printer broadcasts a reconnection event containing the printer's network address (step S54). Alternatively, instead of a broadcast event, the printer may scan possible network addresses (e.g. IP addresses) within a certain range (e.g. a subnet where all IP addresses have the same number except for the last three digits) by sending the reconnection event to all such network addresses sequentially. The printer may also send the reconnection event to specific IP addresses in a point-to-point communication. While many host computers may be connected to the same network, those host computers that are not running a printer reconnection application will ignore the reconnection event. The host computer that has the printer reconnection application running on it receives the reconnection event and reconnects the printer using the printer's network address contained in the reconnection event (step S55). In this step, the host computer also sends a reconnection acknowledgement message to the printer. The printer receives the acknowledgement message and terminates the broadcast (step S56).

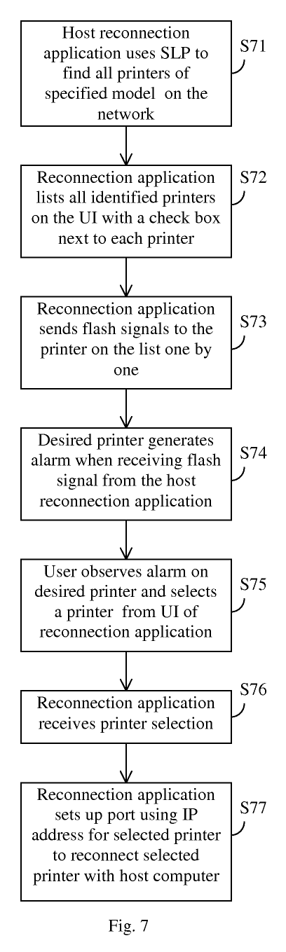

The second reconnection method is described with reference to FIG. 7. The host computer wishing to reconnect with a printer runs a reconnection application, which uses the SLP (service location protocol) to search for all printers of a specific model that are connected to the network and obtain their network addresses (step S71). The specific printer model is the one that matches the printer driver on the host computer for which the host computer is performing reconnection. The reconnection program then displays a list of such identified printers (the candidate printers) on the program's UI (user interface) together with a selection feature associated with each candidate printer (e.g. a check box next to each printer) (step S72). The candidate printers in the list may be identified by their network addresses and/or by other identifiers (such as numerals).

The reconnection application on the host computer then sends flash signals to all candidate printers in a sequential, non-concurrent manner (step S73). Simultaneously, the reconnection application generates an indication on the UI to indicate which candidate printer it is currently sending a flash signal to. The flash signal causes the printer to which it is sent to generate a perceivable alarm, such as an audible alarm or a visual alarm (step S74). For example, the flash signal may cause one or more buttons on the printer to light up or flash. The flash signals from the host computer are such that the alarm on different printers will be set off one by one, i.e., non-concurrently. For example, the reconnection application may send a flash signal to a candidate printer to cause its alarm to go off continuously or repeatedly for a predetermined period of time, and waits for the predetermined period of time to lapse before sending a flash signal to the next candidate printer, etc. In another example, the reconnection application repeatedly sends a flash signal to a candidate printer for a predetermined period of time to cause the printer's alarm to go off during that period of time, and then repeatedly sends a flash signal to the next candidate printer for a predetermined period of time, etc.

While the flash signals are being sent to the printers, the user observes the printer which he desires to reconnect with the host computer, and correlates the timing of the alarm on that printer with the timing of the flash signals sent by the host computer. For example, if the user observes that the desired printer gives out an alarm when the host computer is sending the flash signal to the second candidate printer listed on the UI, then the user will determine that the desired printer is the second printer listed on the UI. The user then selects the appropriate candidate printer from the list on the UI using the selection feature associated with that printer (e.g. by checking the box next to the second printer on the list in the above example) (step S75). The reconnection application receives the user selection of printer (step S76), and sets up a new port with the network address for the selected printer to reconnect the desired printer with the host computer (step S77).

In step S75, the user is required to observe the desired printer as well as the UI on the host computer to determine the correlation between the alarm on the desired printer and the flash signals sent by the host. This step is more conveniently performed when the desired printer is located relatively close to the host computer. The reconnection application may alternatively require the user to initiate the sending of the flash signal to the each candidate printer. In other words, the host computer continues to send the flash signal to a printer, and after the user observed the designed printer, the user instructs the reconnection application to start sending the flash signal to the next candidate printer on the list, etc. This alternative method is especially convenient when the desired printer is located relatively far away from the host computer.

In the process of FIG. 7, steps S71-S73, S76 and S77 are carried out by the reconnection application running on the host computer. The host computer has a structure shown in FIG. 1. Step S74 is carried out by the printer. The printer has a structure similar to that illustrated in FIG. 2 except that the reconnect button 2200 is not necessary. Instead, an alarm generator 2210 is provided to generate the audible or visual alarm described above. The alarm generator may be a beeper, a dedicated signal light, one or more buttons that can be lit up, etc. In one particular example, the printer implements both the first and the second reconnection method, and the reconnect button 2200 and the alarm generator 2210 are combined into one flash button which can light up or flash when carrying out the second method and can be pressed when carrying out the first method.

In a system where many host computers and printers are connected to the same network, it may happen that two or more computers are trying to reconnect to respective printers at the same time. In such a case, a first printer with which a first computer is trying to connect may generate an alarm when it receives a flash signal from a second computer which is trying to reconnect with a second printer. To prevent such potential confusion, according to one embodiment of the present invention, the flash signal sent by each host computer carries an alarm pattern code that determines a pattern of the alarm generated alarm generator 2210. In one example, the alarm is generated by flashing the 0-9 numeric buttons on the printer control panel, and the buttons flash in a particular order, such as 1-2-1-2, or 1-3-1-3, etc. as determined by the alarm pattern code. In another example, the alarm is generated by a beeper and the beeping pattern (number of beeps, combination of short and long beeps, etc.) is determined by the alarm pattern code. The UI of the reconnection application includes an alarm pattern chooser to allow the user to choose or specify the alarm pattern code. Then, in step S75, the user observes the pattern of the alarm generated by the desired printer to confirm that it agrees with the pattern he has chosen from the reconnection application. If the alarm generated by the desired printer has a pattern different from that chosen by the user, it is likely that the printer is receiving a flash signal from another host computer by coincidence, in which case the user will ignore that alarm.

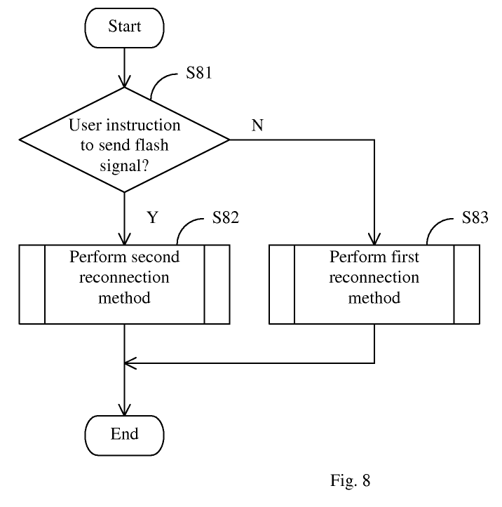

As stated earlier, the first and second reconnection methods may be implemented alone or in combination. In particular, a reconnection application 1100 on the host computer may implement both methods in the alternative, and allow the user to choose which method to use. For example, as shown in FIG. 8, the UI may present a button by which the user instructs the reconnection application to carry out the second reconnection method (step S82), i.e., by sending out the flash signal, etc. If the user does not click this button (“N” in step S81), the reconnection application carries out the first reconnection method (step S83), i.e. by waiting for a reconnection event from the printer, etc.

Embodiments of the present invention provide an easier and simpler mechanism that improves the user experience for reconnecting to a printer when its network address changes. The host computer obtains the printer's network address without requiring the user to manually input it. This process eliminates the need to manually find out the printer's network address or type the network address on the host.

It will be apparent to those skilled in the art that various modification and variations can be made in the printer reconnection methods of the present invention without departing from the spirit or scope of the invention. Thus, it is intended that the present invention cover modifications and variations that come within the scope of the appended claims and their equivalents.

What is claimed is:

1. In a system including one or more host computers and one or more printers connected to a network, a method for reconnecting a first one of the printers to a first one of the host computers, comprising:
(a) manually causing the first printer to generate a reconnection event containing a network address of the first printer, the network address having been dynamically assigned to the first printer and stored in a memory of the first printer;
(b) the first printer sending the reconnection event over the network to be transmitted to the one or more host computers;
(c) the first host computer receiving the reconnection event and extracting the network address of the first printer; and
(d) the first host computer reconnecting to the first printer using the extracted network address of the first printer.

2. The method of claim 1, further comprising:
the first host computer sending a reconnection acknowledgement message to the first printer; and
the first printer receiving the reconnection acknowledgement message.

3. The method of claim 1, wherein step (b) includes broadcasting the reconnection event over the network to all host computers.

4. In a system including one or more host computers and one or more printers connected to a network, a method for reconnecting a first one of the printers to a first one of the host computers, comprising:
(a) the first host computer obtaining a plurality of candidate printers with their network addresses, the candidate printers including the first printer;
(b) the first host computer displaying a list of the candidate printers on a user interface;
(c) the first host computer sending flash signals to the candidate printers one by one;
(d) the first printer generating an alarm in response to receiving a flash signal from the host computer;
(e) a user correlating the alarm of the first printer with a timing of the flash signals sent by the host computer;
(f) the user selecting one of the candidate printers on the user interface based on the observation; and
(g) the host computer reconnecting to the selected printer.

5. The method of claim 4, wherein the alarm is an audible or visual alarm.

6. The method of claim 4, wherein the flash signals sent by the first host computer contain an alarm pattern code, and wherein the alarm generated by the first printer has a pattern determined by the alarm pattern code.

7. The method of claim 6, wherein the alarm is generated by a plurality of buttons flashing in a sequence determined by the alarm pattern code.

8. The method of claim 4, wherein in step (a), the first host computer obtains the candidate printers and their network addresses using service location protocol.

9. A printer, comprising:
a processor;
a memory for storing an IP a network address of the printer, the network address having been dynamically assigned to the printer;
a manual input device connected to the processor; and
a network interface for connecting the printer to a network;
wherein the processor is programmed to generate a reconnection event in response to an input from the manual input device and transmitting the reconnection event to a network via the network interface, the reconnection event containing a network address of the printer.

10. The printer of claim 9, wherein the processor is programmed to repeatedly transmit the reconnection event to the network for a predetermined period of time or until a reconnection acknowledgement message is received from the network.

11. The printer of claim 9, further comprising an alarm generator for generating an alarm in response to receiving a flash signal from the host computer.

12. The printer of claim 11, wherein the alarm generator generates an audible or visual alarm.

13. The printer of claim 11, wherein the alarm generator includes one or more flash buttons capable of lighting up or flashing.

14. The printer of claim 11, wherein the flash signals from the first host computer contains an alarm pattern code, and wherein the alarm generator includes one or more flash buttons capable of flashing in a sequence determined by the alarm pattern code.

15. A computer program product comprising a computer usable medium having a computer readable program code embedded therein for controlling a host computer, the computer readable program code configured to cause the host computer to execute a process for reconnecting a printer, the host computer and the printer being connected to a network, the printer capable of transmitting a reconnection event over the network, the reconnection event containing a network address of the printer, the process comprising:
receiving the reconnection event from the printer via the network;
extracting the network address of the printer from the reconnection event; and
reconnecting to the printer using the extracted network address of the printer.

16. The computer program product of claim 15, wherein the process further comprises:
transmitting a reconnection acknowledgement message over the network.

17. A computer program product comprising a computer usable medium having a computer readable program code embedded therein for controlling a host computer, the computer readable program code configured to cause the host computer to execute a process for reconnecting a printer, the host computer and the printer being connected to a network, the process comprising:
(a) obtaining a plurality of candidate printers with their network addresses, the candidate printers including the first printer;
(b) displaying a list of the candidate printers on a user interface;
(c) sending flash signals to candidate printers one by one;
(d) receiving a selection by a user indicating one of the candidate printers; and
(e) reconnecting to the selected candidate printer.

18. The computer program product of claim 17, wherein in step (c), the flash signals contain an alarm pattern code defining a pattern of alarm to be generated by the printer.

19. The computer program product of claim 17, wherein in step (a), the candidate printers and their network addresses are obtained using service location protocol.
